(19) United States
(12) Patent Application Publication
(10) Pub. No.: US 2011/0193692 A1
(43) Pub. Date: Aug. 11, 2011

(54) Anti-theft system for vehicle

(76) Inventor: Jian-Jhong Fong, Taiwan (TW)

(21) Appl. No.: 13/122,982

(22) PCT Filed: Oct. 10, 2008
(86) PCT No.: PCT/CN2008/072636

§ 371 Date: Apr. 7, 2011

(51) Int. Cl. B60R 25/10

(52) U.S. Cl. 340/426.11

(57) ABSTRACT

An anti-theft system for vehicle includes a lock mechanism comprising an anti-theft steering shaft lock and a hood lock; an access controller comprising a programmable processor, a digital identification device, a receiver, and a remote control; a hand brake sensor; a seat pressure sensor; a door lock sensor; a lock release unit; a driving unit; a vibration sensor unit; a deactivation unit; and an alarm unit wherein the access controller is adapted to lock or unlock the anti-theft steering shaft lock, and lock and unlock the hood lock.

### BACKGROUND OF THE INVENTION

1. Field of the Invention

The invention relates to anti-theft locks for vehicles and more particularly to an anti-theft system for a motor vehicle or electric vehicle with improved characteristics.

2. Description of Related Art

Thieves steal vehicles for various purposes. Some of the thieves drive stolen vehicles for fun. Some others drive stolen vehicles for worse crimes. Some others sell stolen vehicles. Some others dismantle stolen vehicles and sell the parts. Some others extort ransom from vehicle owners. A lot of vehicle thefts are still reported. To stop vehicle theft from occurring, a lot of anti-theft locking devices have been devised. Engine code locks, GPS (Global Positioning System) devices, and chip locks (e.g., RFID (radio frequency identification) type locks) are becoming popular nowadays. They are, however, expensive. Moreover, none of them has enjoyed a long term of success. Each of these anti-theft locking devices or locks is integrated with a steering wheel. The anti-theft locking device is used to allow the rotation of the steering wheel relative to the steering column. Thus, a thief can maneuver the steering wheel but cannot maneuver the steering column.

There have been crane-shaped locks, gear stick locks and steering wheel locks in early days. However, none of these locks has enjoyed a long term of success. For example, a steering wheel can be released by picking a steering wheel lock. Alternatively, the steering wheel can be cut from a steering column. The steering column can be clamped and maneuvered by a tool. The tool can be maneuvered to rotate the steering column and therefore steer a vehicle.

Further, prior art systems require a great number of parts resulting in a complex structure and high manufacturing costs. Thus, the need for improvement still exists.

### SUMMARY OF THE INVENTION

It is therefore one object of the invention to provide an anti-theft system for a vehicle comprising a lock mechanism comprising an anti-theft steering shaft lock and a hood lock; an access controller comprising a programmable processor, a digital identification device, a receiver, and a remote control; a hand brake sensor; a seat pressure sensor; a door lock sensor; a lock release unit; a driving unit; a vibration sensor unit; a deactivation unit; and an alarm unit; wherein the access controller is adapted to lock or unlock the anti-theft steering shaft lock, and lock and unlock the hood lock.

In a first aspect of the invention one of a plurality of biometric identifications including fingerprint identification, retinal scan, facial recognition, and voice recognition can be performed to activate at least one of the programmable processor, the digital identification device, the receiver, and the remote control for access identification.

In a second aspect of the invention there is further provided a transmitter electrically connected to the alarm so that the alarm can be generated in a form of an alarm signal which can be transmitted to a 3G mobile phone or a GPS device.

In a third aspect of the invention there is further provided an ultrasonic door lock sensor for detecting a door opening and sending a corresponding signal to the access controller so that the access controller can be activated to start the personal identification.

In a fourth aspect of the invention the hood lock is disposed in a front end of a hood including a front latch; the hood lock comprises a base plate including a curved first cut on edge; a rectangular housing integrally formed with one end of the base plate and including a channel member through one side; a planar first formation including a curved second cut on edge and a projecting apex; a bent second formation; a link pivotably secured the first formation and the second formation together; a first spring having one end fastened at the first formation and the other end fastened at the second formation; a second spring mounted on the vase plate and having one end fastened at the first formation; a third spring mounted on the base plate and having one end disposed below the aligned first and second cuts to urge against one end of the latch from below; a hollow guide of rectangular section including a circular tunnel on one surface and a rectangular opening on an adjacent surface; a lock rack slidably provided in the guide and including a bottom groove and teeth partially open to the rectangular opening; a 90-degree bent plate with the guide disposed therein and including a channel aligned with the tunnel; a battery powered drive member including a pinion meshing with the teeth, the drive member disposed at both sides of one half portion of the bent plate; and a sheathed pulling member including a bifurcation at one end, the bifurcation being pivotably secured to the second formation, a handle at the other end, a narrow section disposed in the guide under the lock rack, and a flexible rod passing through entire length of the pulling member except both ends thereof; the pulling member other than the narrow section is adapted to slidably pass the channel, the tunnel, and the channel member; the narrow section is lockingly engaged with the groove in a locked position of the hood when the vehicle is driving; and the guide, the lock rack, the bent plate, and the drive member are disposed in the housing.

The above and other objects, features and advantages of the invention will become apparent from the following detailed description taken with the accompanying drawings.

### BRIEF DESCRIPTION OF THE DRAWINGS

FIG. 1 is a schematic top view of an automobile incorporating an anti-theft system according to the invention;

FIG. 2 is a block diagram of the anti-theft system;

FIG. 3 is a perspective view of a steering column and adjacent components incorporating a first preferred embodiment of anti-theft system of the invention, the first preferred embodiment being implemented as an anti-theft steering shaft lock;

FIG. 4 is an exploded view of FIG. 3;

FIG. 5 is a longitudinal sectional view of an intermediate portion of the anti-theft steering shaft lock of FIG. 2 in an unlocked state;

FIG. 6 is a view similar to FIG. 5 showing the anti-theft steering shaft lock in a locked state;

FIG. 7 is a perspective view of the guide, the pinion, and the drive member of the anti-theft steering shaft lock;

FIG. 8 is a perspective view of a hood lock for a vehicle as a second preferred embodiment of anti-theft system of the invention;

FIG. 9 is a longitudinal sectional view of the cover with some components of FIG. 8 being assembled therein where a locking operation is being initiated by the access controller;

FIG. 10 is a view similar to FIG. 9 where an unlocking operation is being shown;

FIG. 11 is a side elevation of the assembled hood lock of FIG. 8 where the hood lock is locked;

FIG. 12 is a view similar to FIG. 11 where an unlocking operation by pulling a handle is being shown;

FIG. 13 is an exploded view of the steering column and adjacent components incorporating another configuration of the first preferred embodiment of anti-theft system of the invention, another configuration of the first preferred embodiment being implemented as an anti-theft steering shaft lock; and

FIG. 14 is a fragmentary view of the lock rack disposed in the guide and adjacent components of FIG. 13 showing the flexible rod being locked by the lock rack after locking both the hood lock and the anti-theft steering shaft lock.

### DETAILED DESCRIPTION OF THE INVENTION

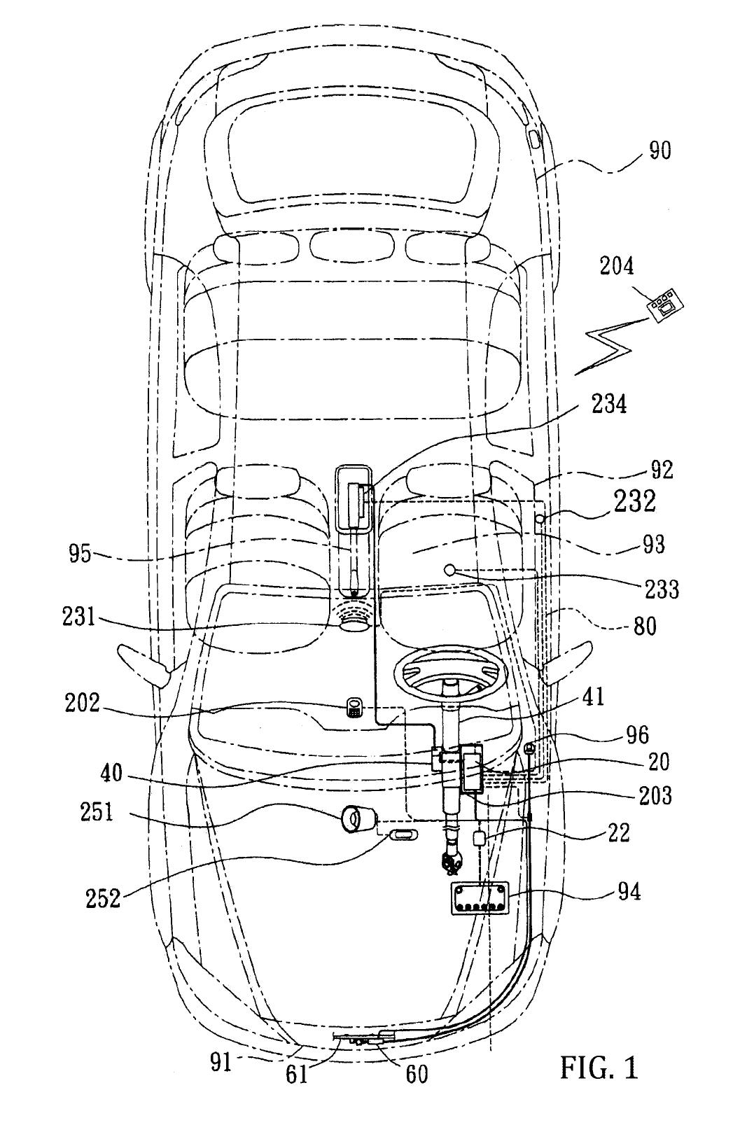

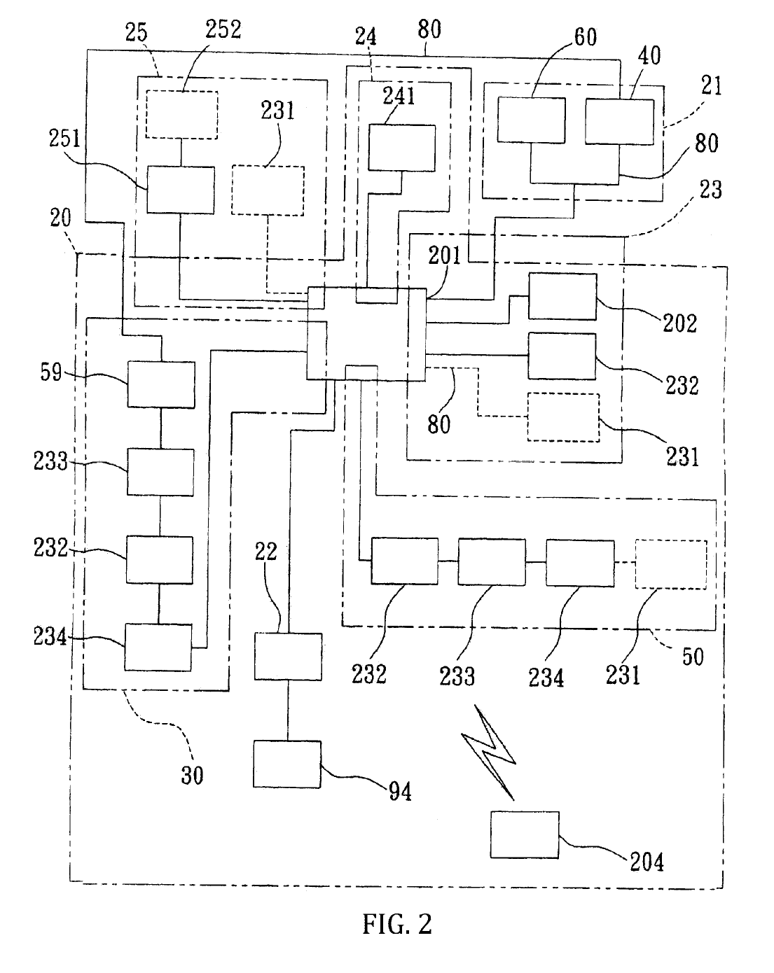

Referring to FIGS. 1 and 2, an anti-theft system for a vehicle (e.g., car as shown) 90 in accordance with the invention is shown and comprises the following components as discussed in detail below. It is noted that the vehicle of the invention can be either a motor vehicle or an electric vehicle.

An access controller 20, a lock mechanism 21 including an anti-theft steering shaft lock 40 and a hood lock 60, and an alarm unit 25 are provided. The access controller 20 comprises a lock release unit 23, a driving unit 50, a vibration sensor unit 24, a door lock sensor 232, a seat pressure sensor 233, and a hand brake sensor 234. An electrical wiring assembly (i.e., wire) 80 is employed to connect above components together. Power of the anti-theft system is provided by a battery 94 in an engine compartment or a cigarette charger (not shown). The battery 94 may be provided in the trunk in other embodiments. A switch 22 is interconnected the battery 94 and the access controller 20. The access controller 20 comprises a programmable processor 201 connected to the wire 80, a digital identification device, a receiver 202, and a remote control 204. The access controller 20 is enclosed in a housing member 203 besides a steering column 41 and distal a steering wheel (not numbered). The housing member 203 is adjacent the anti-theft steering shaft lock 40. The anti-theft steering shaft lock 60 and the hood lock 40 are electrically interconnected by the access controller 20.

The vibration sensor unit 24 comprises a vibration sensor 241. The alarm unit 25 comprises an audible alarm 251. The alarm 251 can be activated to make a buzzing sound by the vibration sensor 241 when a predetermined number of vibrations due to (e.g., towing of the car 80, or door opening by a thief) within a predetermined period of time have been detected by the vibration sensor 24. The alarm unit 25 is disposed under the hood for protection.

The alarm unit 25 may further comprises a transmitter 252 electrically connected to the alarm 251 in other embodiments. The above alarm issuance may be in the form of an alarm signal which can be transmitted to an external receiver (e.g., 3G (third generation mobile communications) mobile phone, GPS device, or the like held by the car owner who is located far away from the car) via the transmitter 252. Thus, the car owner may be aware of the alarm in real time.

Components and operation of the lock release unit 23 are described below. The door lock sensor 232 will be activated when a drives unlock a door lock and opens a door 92 prior to sitting on the driver seat 93. Alternatively, an ultrasonic door lock sensor 231 may be installed as a replacement or in addition to the door lock sensor 232. Each of the door lock sensor 232 and the ultrasonic door lock sensor 231 can detect an activation (i.e., door opening) signal to the access controller 20. The access controller 20 then may be activated to ask the person opening the door 92 to identify him/herself. The person (if being the owner of the car) may operate a remote control 204 to control the access controller 20. A receiver 202 may be then activated to receive and identify whether the person is the owner of the car or a person authorized by the owner to drive the car. Both an anti-theft steering shaft lock 40 and a hood lock 60 will be unlocked by the access controller 20 if the identification is correct.

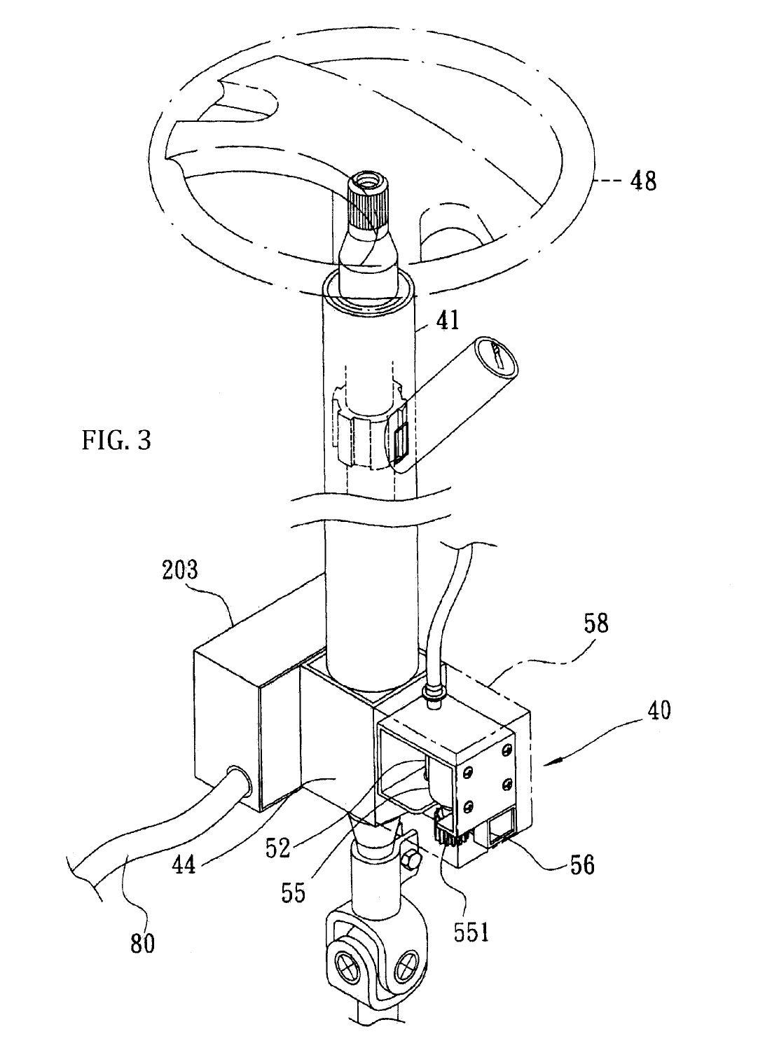

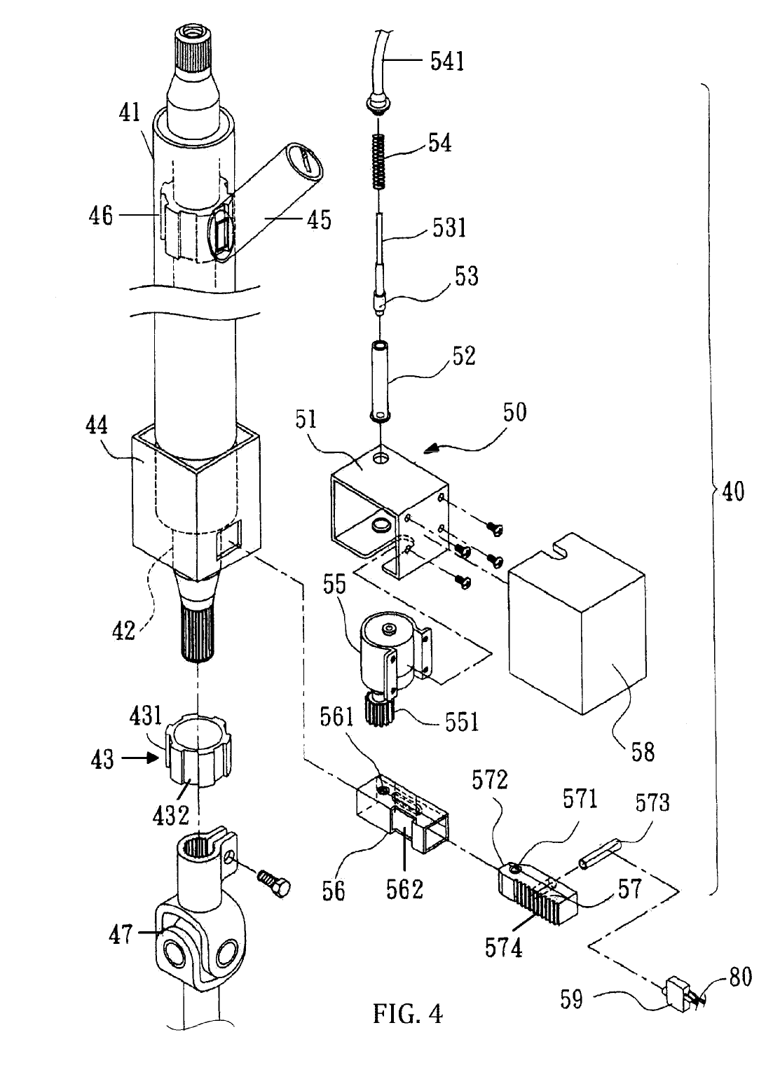

Referring to FIGS. 3 to 7 in conjunction with FIGS. 1 and 2, a first preferred embodiment of the anti-theft system of the invention is shown. The first preferred embodiment is implemented as an anti-theft steering shaft lock 40 as described in detail below. The anti-theft steering shaft lock 40 is mounted in a steering column 41 which has a steering shaft 42 obliquely extending upward to rotatably connect to a steering wheel 48 at an upper end. A lower end of the steering shaft 42 is secured to a universal joint 47. The anti-theft steering shaft lock 40 is mounted on the steering column 41 proximate to the universal joint 47.

The anti-theft steering shaft lock 40 comprises a limit unit 43, a driving unit 50, a trigger, and a wire 80. The limit unit 43 is provided on a lower portion the steering shaft 42. The anti-theft steering shaft lock 40 can be actuated by the driving unit 50 to either lock the limit unit 43 for anti-theft or unlock same for driving a vehicle. The limit unit 43 is mounted on a lower end of the steering wheel 42 proximate to the universal joint 47. The limit unit 43 is implemented as a collar 431 having a plurality of spaced parallel grooves 432 on an outer surface. The collar 431 can co-rotate with a collar member 46 in the steering column 41. The collar member 46 is provided on the steering shaft 42 in the steering column 41. The collar member 46 can be turned by turning a car key inserted into a keyhole of a car lock 45. As a result, the collar 431 turns.

The anti-theft steering shaft lock 40 further comprises a hollow guide 56 of rectangular section, the guide 56 including a hole 561 on top, a rectangular opening 562 on one side, and an elongated slot 563 on the other side; and a lock rack 57 slidably provided in the guide 56, the rectangular-section shaped lock rack 57 including teeth 574 on one side, a lock section 572 at one end, the lock section 572 being adapted to move into the groove 432 or not, a top locking receptacle 571 proximate the lock section 572, a cylindrical recess (not numbered) on the other side opposing the teeth 574, and an arm 573 partially disposed in the recess and projecting out of the slot 563. The driving unit 50 is electrically connected to the access controller 20 of the car and can be actuated by the access controller 20. The driving unit 50 comprises a battery powered drive member (e.g., servo motor, servo motor with a reduction gear, motor, or motor with a reduction gear) 55, a parallelepiped housing 51 with the drive member 55 mounted therein, the housing 51 being provided on top of the guide 56 and affixed to the steering column 41, and a pinion 551 rotatably connected to a driving shaft of the drive member 55, the pinion 551 engaging the teeth 574 and being disposed under the housing 51.

The anti-theft steering shaft lock 40 further comprises a guide sheath 52 mounted between top and bottom of the housing 51, a lock pin 53 provided in the guide sheath 52 and having a cable 531 extending upward, a helical spring 54 provided in the guide sheath 52 and put on portions of the lock pin 53 and the cable 531, and a sleeve 541 put on a portion of the cable 531 externally of the housing 51. The cable 531 is connected to a hand brake of an automobile. The lock rack 57 is either held motionless when the bottom end of the lock pin 53 enters the locking receptacle 571 or allowed to move when the lock pin 53 clears the locking receptacle 571 by pulling the cable 531. The anti-theft steering shaft lock 40 further comprises a parallelepiped protective cover 58 for receiving the driving unit 50 and associated components, and a trigger 59 mounted on the guide 56 proximate the slot 563. The trigger 59 is electrically connected to the wire 80.

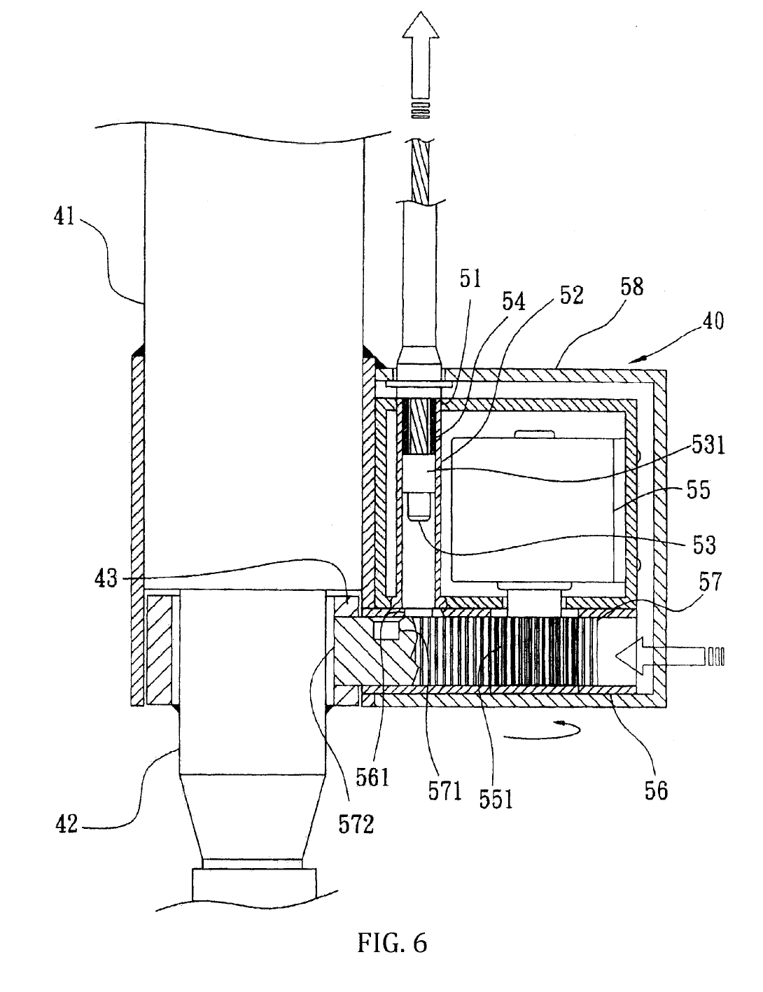

Operations of the invention are described in detail below. A driver may remove a car key from the car lock 45 to lock the engine after stopping. Next, the driver may upward pull a hand brake 95 to park. The lock pin 53 is thus pulled upward to clear the locking hole 571 with the spring 54 being compressed as a result of the pulling of the cable 531 which is connected to the hand brake. After the lock pin 53 has cleared the locking hole 571, the driver may enter a password (e.g., personal identification number (PIN)) into a code keypad (not shown) on a dashboard (not numbered) of the car 90 or place an access badge (not shown) proximate to a receiver 202 on the dashboard to activate the driving unit 50 by activating the access controller 20 for identification. Alternatively, the driver may operate one of a plurality of biometric identifications including fingerprint identification, retinal scan, facial recognition, and voice recognition to activate the driving unit 50 by activating the access controller 20 for identification. As shown in FIG. 6, in response to the identification being true, the drive member 55 is activated to counterclockwise rotate the pinion 551 which in turn moves the lock rack 57 leftward due to meshing with the teeth 574. The movement of the lock rack 57 will be stopped when the lock section 572 fully engages with the groove 32. As a result, the steering column 41 is locked.

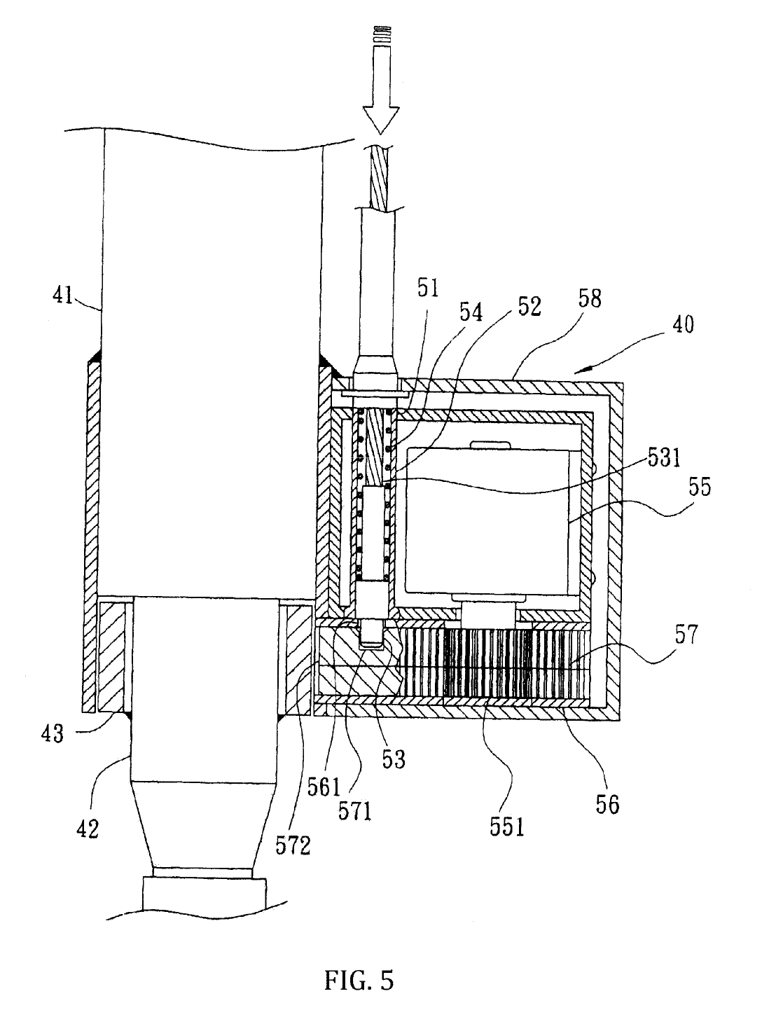

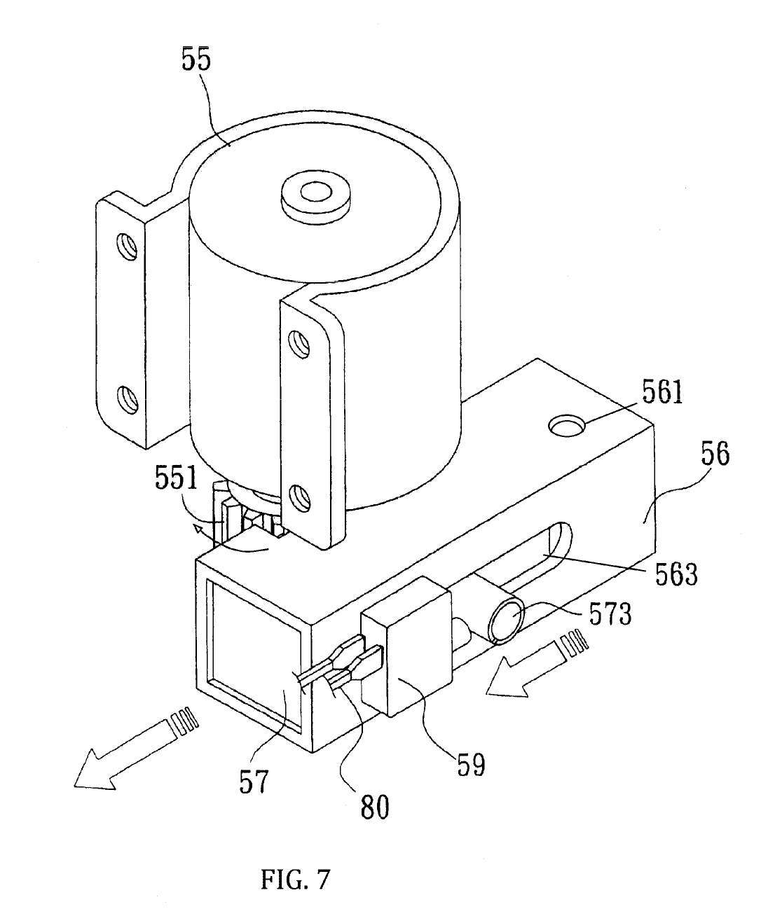

For driving the car, the driver may use the PIN input or the access badge reading method to activate the driving unit 50 by activating the access controller 20 for identification. Alternatively, the driver may operate one of the above biometric identifications to activate the driving unit 50 by activating the access controller 20 for identification. As shown in FIGS. 5 and 7, in response to the identification being true, the drive member 55 is activated to clockwise rotate the pinion 551 which in turn moves the lock rack 57 rightward due to meshing with the teeth 574. The movement of the lock rack 57 will be stopped when the lock section 572 fully disengages from the groove 32 and the arm 573 is stopped by the trigger 59 after a predetermined period of time (e.g., a number of seconds). The trigger 59 is activated to send an electrical signal to the access controller 20 so that the access controller 20 is aware of an unlocking operation by the owner (or an authorized person). As a result, the steering column 41 is unlocked. Thereafter, the driver may counterclockwise pivot the hand brake 95 (i.e., release the hand brake 95). Moreover, the door 92 is locked as a result of cooperating with the door lock sensor 232, the hand brake sensor 234, and the seat pressure sensor 233. The access controller 20 in turn deactivates the driving unit 50, the vibration sensor unit 24, and the alarm unit 25. Note that the trigger 59, the door lock sensor 232, seat pressure sensor 233, and the hand brake sensor 234 are included in a deactivation unit 30. The driving unit 50 also comprises the ultrasonic door lock sensor 231, the door lock sensor 232, the seat pressure sensor 233, and the hand brake sensor 234.

At the same time, the lock pin 53 is pulled downward to enter the locking hole 571 due to the expansion of the spring 54 and the loosening of the cable 531. As a result, the lock rack 57 is kept motionless (i.e., locked). Then the driver may insert the car key in the car lock 45 and turn the same clockwise (i.e., unlocked) to start the ignition. In short, a simple insertion of a key into the car lock 45 by an unauthorized person (e.g., thief) cannot start the ignition. Note that the above mechanisms and operations are equally applicable to motorcycles, bicycles, trains and boats.

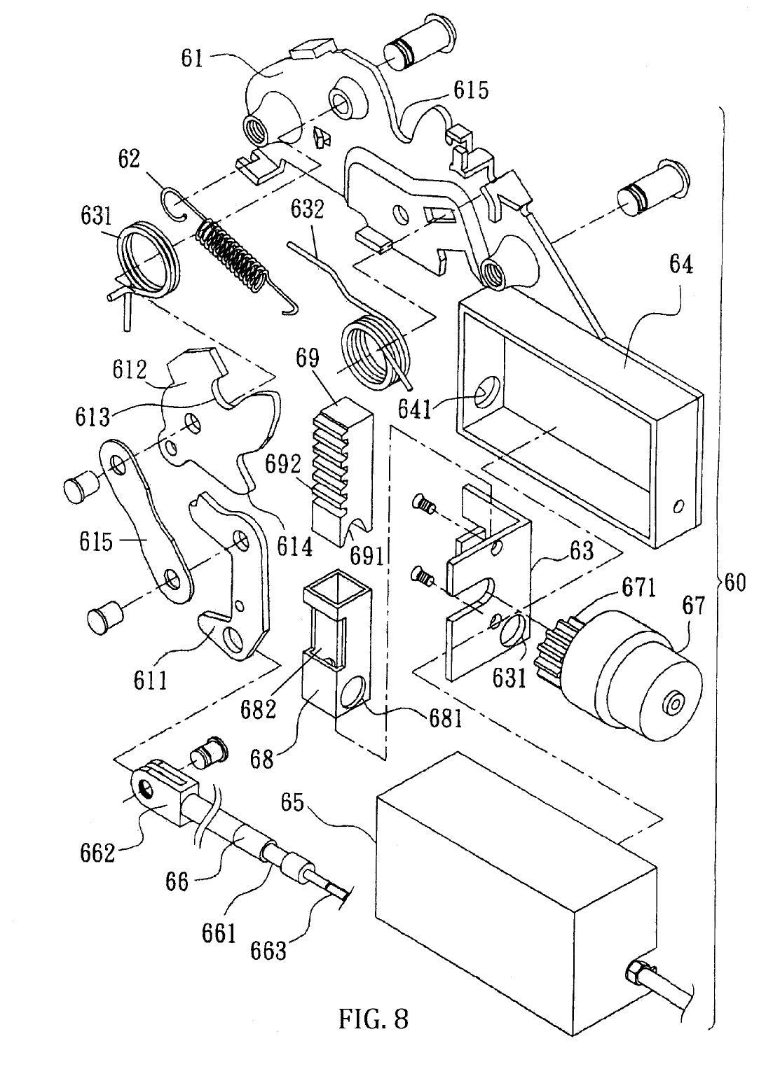

Referring to FIGS. 8 to 12 in conjunction with FIGS. 1 to 7, a hood lock 60 for a vehicle as a second preferred embodiment of anti-theft system of the invention is described in detail below. The hood lock 60 is provided at a front end of a hood 91. The hood lock 60 comprises a base plate 61 including a curved first cut 615 on edge; a rectangular housing 64 integrally formed with one end of the base plate 61 and including a channel member 641 through one side; a planar first formation 612 including a curved second cut 613 on edge and a projecting apex 614; a bent second formation 611; a link 615 pivotably secured the first formation 612 and the second formation 611 together; a tension coil spring 62 having one end fastened at the first formation 611 and the other end fastened at the second formation 611; a first helical spring 631 mounted on the vase plate 61 and having one end fastened at the first formation 612; a second helical spring 631 mounted on the base plate 61 and having one end disposed below the aligned first cut 615 and second cut 613 to urge against one end of a latch 911 secured to the front end of the hood 91 from below; a hollow guide 68 of rectangular section including a circular tunnel 681 on one surface and a rectangular opening 682 on an adjacent surface; a lock rack 69 slidably provided in the guide 68 and including a bottom groove 691 and teeth 692 partially open to the opening 682; a 90-degree bent plate 63 with the guide 68 disposed therein and including a channel 631 aligned with the tunnel 681; a battery powered drive member (e.g., servo motor, servo motor with a reduction gear, DC (direct current) motor, or DC motor with a reduction gear) 67, the drive member 67 including a pinion 671 rotatably connected to a driving shaft thereof, the pinion 671 engaging the teeth 692, the drive member 67 disposed internally and externally of one half portion of the bent plate 63; a parallelepiped cover 65 matingly mounted on the housing 64; and a sheathed pulling member 66 including a bifurcation 662 at one end, the bifurcation 662 being pivotably secured to the second formation 611, a narrow section 661 disposed in the guide 68 under the lock rack 69 after passing one side of the cover 65, and a flexible rod 663 through the entire length of the pulling member 66 except both ends thereof, the other end of the pulling member 66 formed as a handle 96 accessible at a dashboard of the car. The portion of the pulling member 66 from one side of the cover 65 to the bifurcation 662 other than the narrow section 661 is adapted to slidably pass the channel 631, the tunnel 681, and the channel member 641. The narrow section 661 is lockingly engaged with the groove 691 in a locked position of the hood 91 when the car 90 is driving. It is noted that the guide 68, the lock rack 69, the bent plate 63, and the drive member 67 are disposed in both the housing 64 and the cover 65.

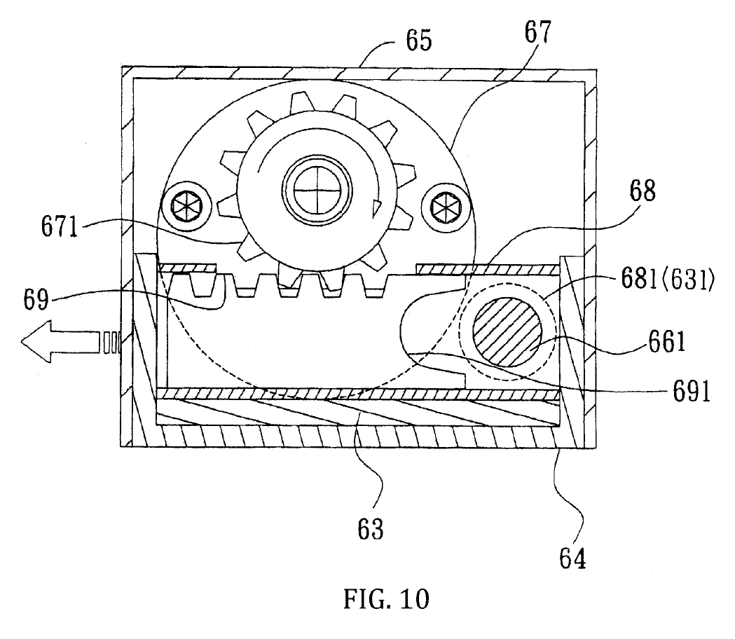

As shown in FIG. 10, the owner of the car (or an authorized person) seated on the driver seat 93 may unlock the anti-theft steering shaft lock 40 to start a hood lock unlocking operation. In the hood lock unlocking operation, the driver member 67 clockwise rotates to move the lock rack 69 as indicated by leftward arrow. This can disengage the groove 691 from the narrow section 661. Thus, the pulling member 66 is free (i.e., unlocked). As a result, the hood 91 can be opened by pulling the handle 96 in a manner known in the art.

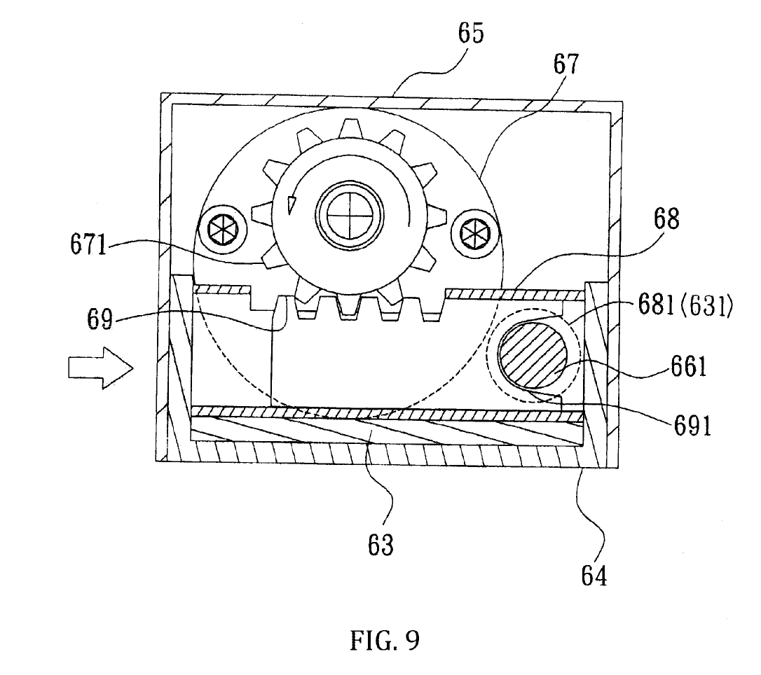

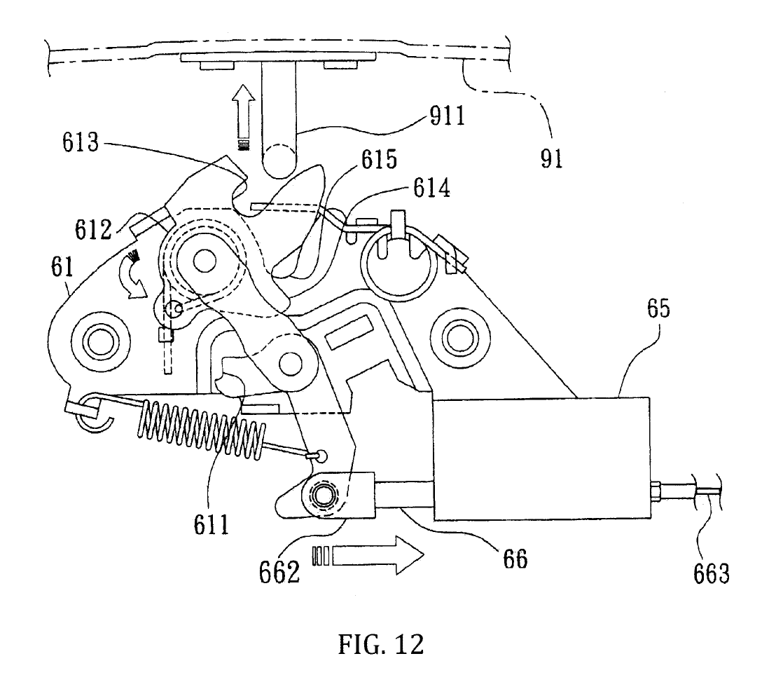

As shown in FIGS. 9 and 12, to the contrary, the driver may lock the anti-theft steering shaft lock 40 to start a hood lock locking operation. In the hood lock locking operation manually, the driver member 67 counterclockwise rotates to move the lock rack 69 as indicated by rightward arrow (see FIG. 9). This can lockingly engage the groove 691 with the narrow section 661. Thus, the pulling member 66 is locked. As a result, the hood 91 cannot be opened by simply pulling the handle 96. This can prevent an unauthorized person from releasing the hood 91 by simply pulling the handle 96 since the pulling member 66 is held motionless (i.e., locked).

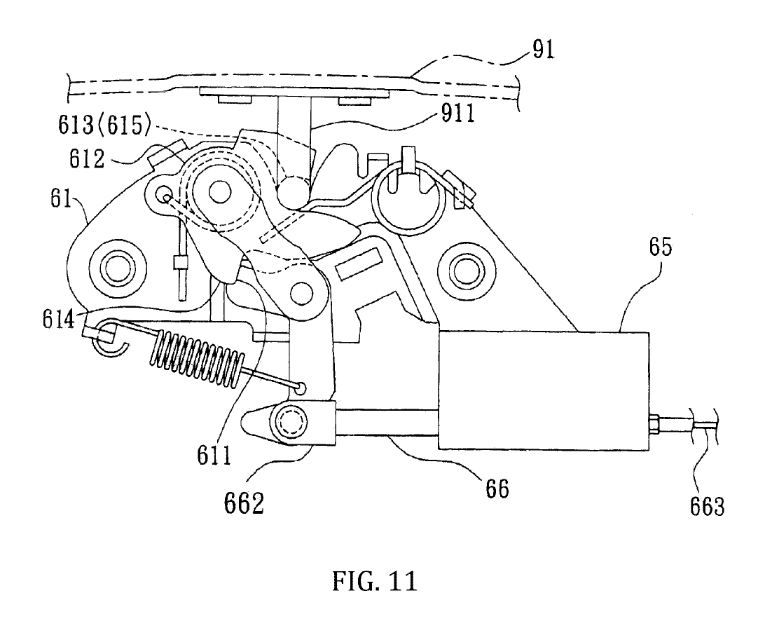

Normal hood opening and locking operations will be described below. As shown in FIG. 11, in a locked position of the hood lock 60, the latch 911 is fastened by the second cut 613. As shown in FIG. 12, for opening the hood 91, a driver may pull the handle 96. Thus, the bifurcation 662 moves rightward with the tension coil spring 62 being expanded, the first formation 612 being pivoted counterclockwise, and the latch 911 being cleared the second cut 613 and the first cut 615. As a result, the hood 91 is released (i.e., unlocked). It is understood that a release of the handle 96 and a pressing of the hood 91 toward the engine compartment will lock the hood 91 again.

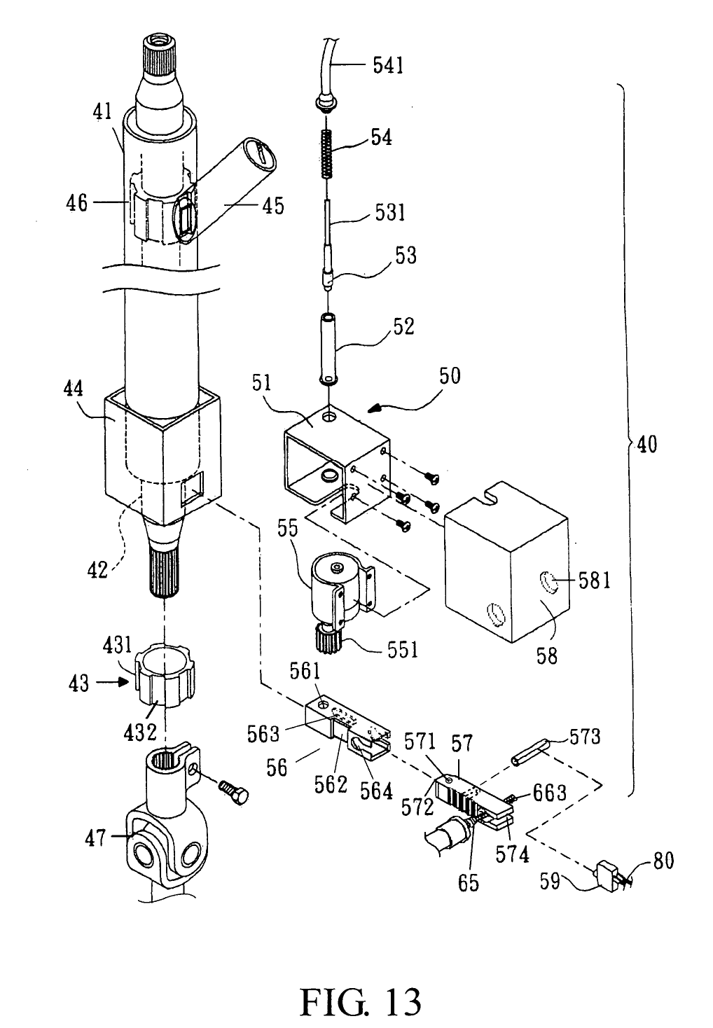

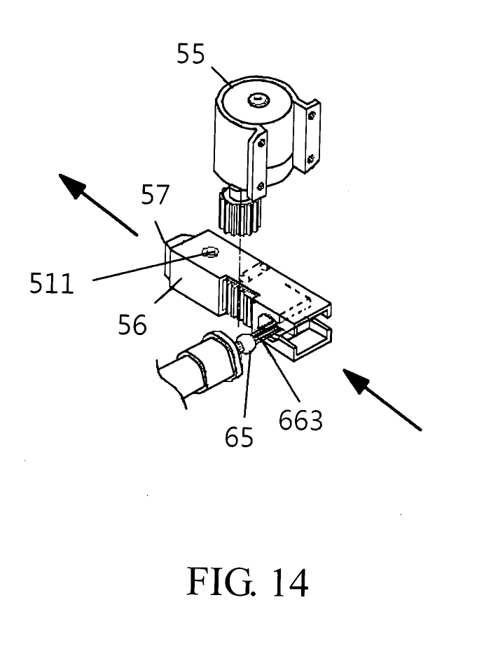

Referring to FIGS. 13 and 14 in conjunction with FIGS. 1 to 12, another configuration of the first preferred embodiment of anti-theft system of the invention is shown. It is characterized as below. The protective cover 58 comprises two through holes 581 on two opposite sides respectively. The guide 56 comprises a hole 561 on top, a rectangular opening 562 on one side, an elongated slot 563 on the other side, and a well 564 on the other end distal the steering column 41. The lock rack 57 comprises teeth 574 on one side, a lock section 572 at one end, the lock section 572 being adapted to move into the groove 432 or not, a top locking receptacle 571 proximate the lock section 572, a cylindrical recess (not numbered) on the other side opposing the teeth 574, an arm 573 partially disposed in the recess and projecting out of the slot 563, and a well 574 on the other end. The rod 663 comprises an enlargement 664 which is smaller than the cylindrical opening of the blind end of the well 564 but larger than the cylindrical opening of the blind end of the well 574. The lock rack 57 can be slidably disposed in the guide 56 to have the wells 564, 574 aligned each other. The rod 663 can be inserted through the through holes 581. Further, the rod 663 can pass the wells 564, 574 to urge the enlargement 664 against the cylindrical opening of the well 574 when both the hood lock 60 and the anti-theft steering shaft lock 40 are locked. To the contrary, the enlargement 664 can pass the well 564 without being stopped by the well 574 because the lock rack 57 has laterally moved to disengage from the rod 663 after unlocking the anti-theft steering shaft lock 40. As a result, the hood lock 60 is unlocked.

While the invention has been described in terms of preferred embodiments, those skilled in the art will recognize that the invention can be practiced with modifications within the spirit and scope of the appended claims.

1. An anti-theft system for a vehicle comprising:
a lock mechanism comprising an anti-theft steering shaft lock and a hood lock;
an access controller comprising a programmable processor, a digital identification device, a receiver, and a remote control;
a hand brake sensor;
a seat pressure sensor;
a door lock sensor;
a lock release unit;
a driving unit;
a vibration sensor unit;
a deactivation unit; and
an alarm unit;
wherein the access controller is adapted to lock or unlock the anti-theft steering shaft lock, and lock and unlock the hood lock.

2. The anti-theft system of claim 1, wherein one of a plurality of biometric identifications including fingerprint identification, retinal scan, facial recognition, and voice recognition can be performed to activate at least one of the programmable processor, the digital identification device, the receiver, and the remote control for access identification.

3. The anti-theft system of claim 2, wherein the access controller is activated to cause the alarm unit to generate an alarm if the access identification fails.

4. The anti-theft system of claim 3, further comprising a transmitter electrically connected to the alarm so that the alarm can be generated in a form of an alarm signal which can be transmitted to a 3G mobile phone or a GPS device.

5. The anti-theft system of claim 1, further comprising an ultrasonic door lock sensor for detecting a door opening and sending a corresponding signal to the access controller so that the access controller can be activated to start the personal identification.

6. The anti-theft system of claim 1, wherein power of the anti-theft system is provided either by a battery in an engine compartment or a trunk or a cigarette charger.

7. The anti-theft system of claim 1, wherein the hood lock is disposed in a front end of a hood including a front latch; the hood lock comprises a base plate including a curved first cut on edge; a rectangular housing integrally formed with one end of the base plate and including a channel member through one side; a planar first formation including a curved second cut on edge and a projecting apex; a bent second formation; a link pivotably secured the first formation and the second formation together; a first spring having one end fastened at the first formation and the other end fastened at the second formation; a second spring mounted on the vase plate and having one end fastened at the first formation; a third spring mounted on the base plate and having one end disposed below the aligned first and second cuts to urge against one end of the latch from below; a hollow guide of rectangular section including a circular tunnel on one surface and a rectangular opening on an adjacent surface; a lock rack slidably provided in the guide and including a bottom groove and teeth partially open to the rectangular opening; a 90-degree bent plate with the guide disposed therein and including a channel aligned with the tunnel; a battery powered drive member including a pinion meshing with the teeth, the drive member disposed at both sides of one half portion of the bent plate; and a sheathed pulling member including a bifurcation at one end, the bifurcation being pivotably secured to the second formation, a handle at the other end, a narrow section disposed in the guide under the lock rack, and a flexible rod passing through entire length of the pulling member except both ends thereof; the pulling member other than the narrow section is adapted to slidably pass the channel, the tunnel, and the channel member; the narrow section is lockingly engaged with the groove in a locked position of the hood when the vehicle is driving; and the guide, the lock rack, the bent plate, and the drive member are disposed in the housing.

8. The anti-theft system of claim 1, wherein in response to energize the driver member in a first operation mode, the driver member clockwise rotates to disengage the groove from the narrow section to allow a subsequent opening of the hood by pulling the handle.

9. The anti-theft system of claim 1, wherein in response to energize the driver member in a second operation mode, the driver member counterclockwise rotates to lockingly engage the groove with the narrow section to lock the hood lock.

10. The anti-theft system of claim 9, wherein the latch is fastened by the second cut when the hood lock is locked.

11. The anti-theft system of claim 1, wherein in response to pulling the handle, the bifurcation moves laterally with the first spring being expanded, the first formation being pivoted counterclockwise, and the latch being cleared both the second and first cuts so as to release the hood.

12. The anti-theft system of claim 7, further comprising a protective cover including two through holes on two opposite sides respectively; wherein the guide further comprises an end well, the lock rack further comprises an end well, and the rod comprises an enlargement smaller than the well of the guide but larger than the well of the lock rack; wherein the rod is adapted to pass through the through holes and the wells so that the enlargement can urge against the well of the lock rack when both the hood lock and the anti-theft steering shaft lock are locked; and wherein in response to unlocking the anti-theft steering shaft lock, the enlargement is adapted to pass both the guide and the lock rack without being stopped by the well of the lock rack so as to unlock the hood lock.
